(19) United States
(12) Patent Application Publication
(10) Pub. No.: US 2008/0010148 A1
(43) Pub. Date: Jan. 10, 2008

(54) Targeted messaging based on attributes

(75) Inventors: Herbert P. Knibiehly, San Francisco, CA (US); Bin Ni, Fremont, CA (US); Igor Pomazanov, Pacheco, CA (US)

Correspondence Address: SCHWEGMAN, LUNDBERG & WOESSNER, P.A., P.O. BOX 2938, MINNEAPOLIS, MN, 55402, US

(73) Assignee: eBay Inc.

(21) Appl. No.: 11/518,326

(22) Filed: Sep. 8, 2006

Related U.S. Application Data
(60) Provisional application No. 60/804,631, filed on Jun. 13, 2006.

(51) Int. Cl. G06Q 30/00

(52) U.S. Cl. 705/14

(57) ABSTRACT

A system and a method publishes a message at a current user web page. A database includes a user list, a current page attribute, and a rule having a first component associated with the user list and having a second component associated with the current page attribute. A rules engine applies the rule using the user list and the current page attribute to publish a message to a user at a current user web page.

### RELATED APPLICATION

This application claims the priority benefit of U.S. Provisional Patent Application No. 60/804,631, filed on Jun. 13, 2006, the contents of which is incorporated herein by reference.

### TECHNICAL FIELD

The present application relates generally to the technical field of data processing and, in one specific example, to a method and system of publishing messages within the network-based system.

### BACKGROUND

In electronic marketplace applications, promotions often entice users to make a purchase that they otherwise may not. Further, promotions often entice users to try a product or service that they might not otherwise try. In many cases, the users try the product or service and become loyal consumers, thereby increasing revenue for the electronic marketplace.

Promotions or messages that are made to a general public may not appeal to each user of the electronic marketplace. Some of the promotions may not be relevant to a particular user, and the user takes additional time to sort through the promotions to determine which ones are relevant. Over time, the users may learn to ignore promotions and messages.

### BRIEF DESCRIPTION OF THE DRAWINGS

Some embodiments are illustrated by way of example and not limitation in the figures of the accompanying drawings in which:

FIG. 1 illustrates a network diagram depicting a system, according to an example embodiment, having a client-server architecture.

FIG. 2 illustrates a block diagram showing marketplace and payment application(s) in an example embodiment.

FIG. 3 illustrates a high-level entity-relationship diagram, illustrating various tables that may be maintained within one or more databases, according to an example embodiment.

FIG. 4A illustrates an interface in an example embodiment.

FIG. 4B illustrates an interaction chart in an example embodiment.

FIGS. 5A to 5E illustrate interfaces according to example embodiments.

FIG. 6 illustrates a flow chart of a method, according to an example embodiment of the present invention.

FIG. 7 illustrates a diagrammatic representation of a machine in the form of a computer system within which a set of instructions, for causing the machine to perform any one or more of the methodologies discussed herein, may be executed, according to an example embodiment.

### DETAILED DESCRIPTION

Example system and method publish a message at a current user web page. A database includes a user list, a current page attribute, and a rule having a first component associated with the user list and having a second component associated with the current page attribute. A rules engine applies the rule using the user list and the current page attribute to publish a message to a user at a current user web page. Targeted promotional placements and inline text messages using knowledge of a user's profile are delivered across an electronic marketplace. The user's profile includes information associated with the user, for example, the language or country associated with the user's online marketplace including messages, items being watched, items won in an auction, items purchased, items not won in an auction, items to be offered for sale, feedback, user account information, user feedback, favorite searches, favorite sellers, favorite categories, among other information for the online marketplace.

At least one of a message or a promotion may be published to the user when the user opens a webpage of a network-based commerce system. The message or promotion may be based on an attribute(s), where the attribute(s) is(are) selected from a group including a user attribute and an attribute associated with the web page itself.

An interface on the webpage may provide an option to the user to select the promotion or the message. The promotion may include a discount associated with the purchase. The message may include recommendations or hints when buying or selling.

The system further comprises an analysis module. In a particular embodiment, the analysis module includes a rules engine to analyze a rule condition associated with each promotion and with each message, and to determine eligibility of a user for a particular promotion or message and/or to filter and prioritize potential promotions and messages to offer to the user.

The analysis module may determine which of many promotions are the optimal ones to offer to the user, while not offering too many promotions so that the user is less likely to be confused, distracted, or overwhelmed by the process. Also, the analysis module includes rules for the number of times a particular message or promotion may be displayed by the user, so that the user may not learn to ignore the promotion or message.

In the case where there are apparent conflicting or overlapping promotions, the analysis module may determine the optimal or higher priority promotion, and just display that one or those ones to the user. Further, promotions that are not relevant to the user may also be filtered by the analysis module.

Eligibility for a particular promotion may be determined by the analysis module in real-time as the user is pulling up a webpage associated with the system. The webpage may include a page published upon logging on to the system, or a home page of the system, or a personalized page of the system or a listing page to list a publication for sale on the system, or a browsing page to search for a particular publication to purchase, or any other page associated with the system. The eligible promotions or messages are analyzed and displayed as part of the currently accessed web page of the system.

Target for promotions may include infrequent sellers, or sellers that do not use any features regularly or just use a certain feature. The user/seller may find that the features do help promote and sell, and sell their items faster, with more bids, and thus, a higher sale price. Real-time promotions may also drive trial of features that the user does not otherwise use. Permanent revenue for the electronic marketplace may be created by adoption lift though changed listing behavior. Target for promotions may also include buyers. Buyers interested in specific type of items may benefit from “Real-time” messages relevant to the type of items they are interested in. Higher buying activity on the marketplace may be created through buying behavior activation.

Targeted content based on user's profile across the network-based commerce system site (Home page, personalized page of the network-based commerce system, user search, etc.) may be delivered. Response to marketing placements (e.g., promotions and/or messages) may be increased due to targeting. Increased relevance of the marketing communications due to targeting may more likely translate into an increase in continued usage by the user.

Success analysis may be conducted by ad-hoc queries, such as number of clicks on a message, selling activity generated by a message, purchases generated by a message; feature adoption rate before, during and after a promotion;

In the following description, for purposes of explanation, numerous specific details are set forth in order to provide a thorough understanding of example embodiments. It will be evident, however, to one skilled in the art that the present invention may be practiced without these specific details.

### Architecture

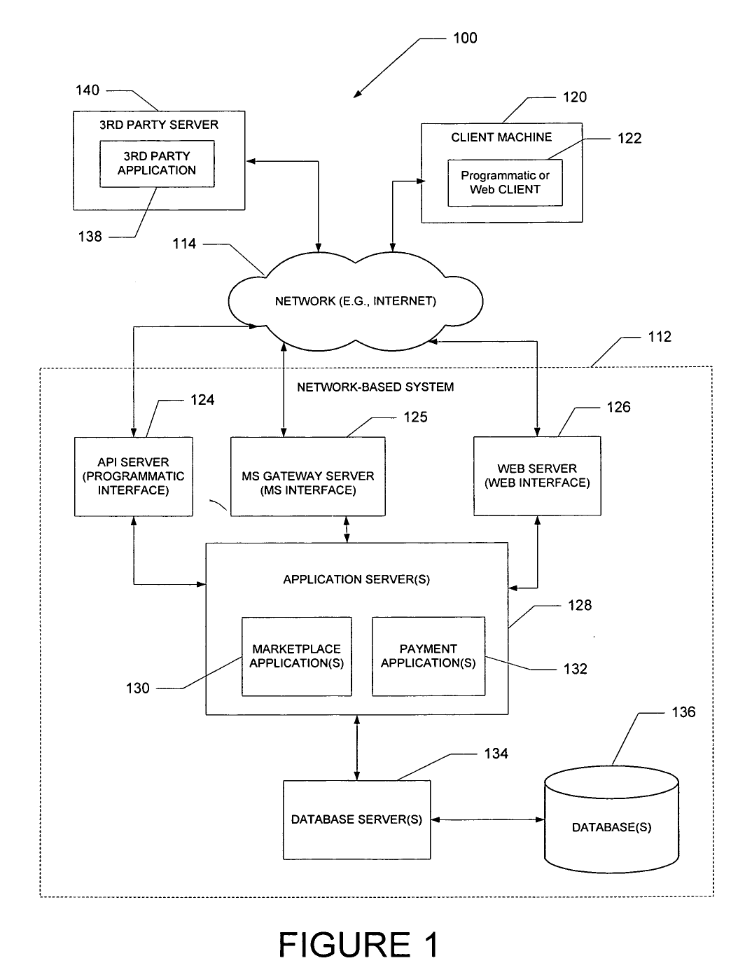

FIG. 1 illustrates a network diagram depicting a system 100 having a client-server architecture, according to an example embodiment of the present invention. A system, in the example form of an electronic system 112, provides server-side functionality, via a network 114 (e.g., the Internet, a public or private telephone network (wireline or wireless), a private wireless network using technologies such as Bluetooth or IEEE 802.11x or other networks) to one or more clients. FIG. 1 illustrates, for example, a client 122, such as a web client (e.g., a browser, such as the Internet Explorer® browser developed by Microsoft®), a device application, and/or a programmatic client executing on client machine 120, e.g. on a network-based device. Further, while the system 100 shown in FIG. 1 employs a client-server architecture, embodiments are of course not limited to such an architecture, and could equally well find applications in a distributed, or peer-to-peer, architecture system.

The network 114 may include a mobile telephone network, a wireless wide area network (WWAN), a wireline telephone network, a wireless local area network (wireless LAN or WLAN), a wireless Metropolitan Area Network (MAN), and/or a wireless personal area network (PAN) (e.g., a Bluetooth® network). Other network-based technologies that may be used to connect include PON, VSAT satellite, Micro-impulse Radar, Radio Frequency identification (RFID), UltraWide Band, and/or Infrared. The network-based device may connect to the web using mobile internet exchange, e.g. Wireless Application Protocol (WAP) and/or Hypertext Transport Protocol (HTTP).

The client machines, including network-based device(s) 120, may include a mobile device, a palmtop computer, a laptop computer, a desktop computer, a personal digital assistant, a cellular telephone, a communications device, a wireless telephone, a land-line telephone, a control system, a camera, a scanner, a television, television cable, a telephone with a web browser, a facsimile machine, a printer, a pager, and/or a personal trusted device. The device 120 may include a card, such as a smart card, a magnetic card, and/or a key card. The device may include a telephone or any device capable of Short Messaging Service (SMS) messaging, instant messaging (IM), text messaging, multimedia messaging service (MMS) messaging and/or generating audio tones, such as dual-tone multi-frequency (DTMF) tones. The device may be browser-enabled. The device 120 may enable mobile videophone communications, digital television signals, and/or digital radio signals. The device may include a receiver to receive near field communications. The scanner device may include a bar code reader/scanner, a Radio Frequency Interface System (RFIS) reader, and/or a symbol reader/scanner.

The device 120 may engage in an interactive message and/or open communication session, such as SMS, IM, electronic mail, xHTML, Wireless Application Protocol (WAP), web, interactive voice response (IVR) and/or other mobile interfaces. The interactive messaging or open communication session may involve multiple technology modalities, e.g., the client user may engage the system via IM and receive a responsive communication from the system 112 via e-mail with an embedded hyperlinked URL directing the client user's device to a WAP or web page or via a telephone call. A hyperlinked URL may be delivered directly to the device from one or more application server(s) 128 of system 112 and may be used to access a web site or a microbrowser, such as a WAP site.

Turning specifically to the network-based system 112, the one or more application servers 128 may host one or more marketplace application(s) 130 and one or more payment application(s) 132. The marketplace application(s) 130 may provide a number of marketplace functions and services to client users, such as a buyer, and/or to third parties, such as sellers or vendors, who access the system 112. The marketplace applications 130 may provide a number of offering mechanisms and price-setting mechanisms; whereby a seller may list goods or services for sale, a seller may promote their offers, a buyer can express interest in or indicate a desire to purchase such goods or services or to donate, and a price can be set for a transaction pertaining to the goods or services. Payment applications 132 may provide a number of payment services and functions to users. While the marketplace and payment applications 130 and 132 are shown in FIG. 1 to both form part of the networked system 112, it will be appreciated that, in alternative embodiments, the payment applications 132 may form part of a payment service that is separate and distinct from the networked system 112.

In the instance where the device 120 accesses the applications 130 and 132 via the MS Interface, the client device 120 may use a messaging service.

The device 120 may access the application servers 128, such as the various marketplace and payment applications 130 and 132, via a system interface. The system interface between the device 120 and the applications 130 and 132 may include a web interface supported by a web server 126, via a programmatic interface supported by an Application Program Interface (API) server 124, and/or via a Messaging Service (MS) Interface supported by the MS Gateway Server 125. The web interface may include a web browser or any microbrowser, such as xHTML or WAP. Similarly, the programmatic client 122 accesses the various services and functions provided by the application server(s) 128, via the programmatic interface provided by the API server 124 and/or the web server 126. The programmatic client 122 may, for example, be a seller application (e.g., the TurboLister® application) to enable sellers to author and manage listings on the networked system 112 in an off-line manner, and to perform batch-mode communications between the programmatic client 122 and the networked system 112.

In an additional embodiment, an application supported by one or more applications of the application server(s) may be downloadable to the network-based device. The device(s) may host the interface associated with the one or more applications of the application server(s) 128. The interface on the device may be an API interface, an MS interface, a web interface, and/or another other appropriate communication interface. Consumer wireless device platforms, such as Java 2 Platform Micro Edition (J2ME), J2SE and J2EE allow developers to use Java and a wireless toolkit to create applications and programs for the device 120. The J2ME interface may include an application programming interface (API) for the device. The application of the programmatic client may also access the Internet using, for example, Binary Runtime Environment for Wireless (BREW).

The client 122, for example, the programmatic client, executed on the client machine 120 may access the application server(s) 128 via the web interface of the web server. The programmatic client may be selected on the device and the Internet may be launched in a background. The programmatic client may additionally or alternatively access the server(s) 128 via the MS interface of the MS Gateway server 125, and/or via the programmatic interface of the API server 124. In an embodiment, the downloaded application described herein may include the programmatic client.

The device 120 may host the interface associated with one or more payment application(s) 132 of the server(s) 128. The client 122, such as the web client, the device application, and/or the programmatic client, may be associated with a financial service provider (FSP) of the payment application(s). In an additional embodiment, the client 122 may be associated with a third party application 138 of a third party server 140. The third party application may, for example, provide one or more promotional, marketplace or payment functions that are supported by the relevant applications of the network-based system 112.

The payment application(s) and/or the financial service provider may operate independent of the third party. The payment application(s) and/or the financial service provider may be related to the third party, in other embodiments.

The payment applications 132 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 130. The payment applications, e.g., a financial service provider, may also extend credit to user, and/or may also have access to other funding sources to complete transactions—e.g. a credit card, a bank account, and/or a credit line. The financial service provider may operate using the payment application(s) 132.

In an example, in response to a prompt from an application executed on the device 120, the user may submit a payment transaction request to the payment application(s). A payment transaction from a user to a third party vendor may then be created. The payment application(s) 132 may send a payment confirmation message, to the user and/or the third party vendor.

The third party or vendor may receive from the payment application(s) and/or the financial service provider (FSP): information regarding a requested payment transaction for a product, a service, or a donation amount, information regarding the shipment address specified by the client user, and payment confirmation. The payment application(s) and/or the financial service provider may secure financial information of the client user with respect to the third party. The FSP may not be sharing the financial information of the client user with the third party. For example, the payment may be received by the third party exclusive of the payment method and/or financial information of the client user, including credit card information, bank information and/or other client user account information.

The system 112 and the various marketplace and payment applications 130 and 132 may also be implemented as standalone software programs, which do not necessarily have networking capabilities. In this example, the device 120 may be directly connected to the marketplace application(s) 130 and/or payment application(s) 132, without using the network 114. The electronic system 112 may be any online marketplace, for example, www.walmart.com. www.ebay.com or www.llbean.com.

The application server(s) 128 may be coupled to one or more database servers 134 that facilitate access to one or more databases 136. The application(s) may have access to the database 136 having, for example, personal user account information. The user account information may include payment information associated with the client user and an address destination of the client user, for example.

The client 122 may operate a program supported by the one or more database server(s) 134. The database server(s) 134 may support one or more account information links on a user interface of the network-based device, for example, using the web client 122. By accessing the database server(s) 134, the client user may add, amend or delete account information of the client user, among other information. In an embodiment, the client user may select a default shipment address and a default payment method in the payment application(s) discussed herein. Depending on whether goods are purchased, a service is requested, a donation is made, or a promotion is selected, a default shipment address, e.g. electronic mail address or a residential address, a business addresses, or a P.O. Box, may be selected by the client user in the payment application(s). One of the default payment methods may include direct transfers from system account balances, internal credit, a gift certificate, a bank account, a debit card, buyer credit, and/or a credit card.

The payment application(s) 132 is further shown to include a payment module 133 to transfer funds (or other value) between users. The payment transfer module 133 may, responsive to the server(s) receiving a payment transaction request from the user, transfer a payment from the user to the third party via the payment application(s) and/or the financial service provider. The payment may be automatically transferred, as discussed herein.

In an example embodiment of the present invention, a buyer may be a client user that submits a purchase request, such as a purchase initiation code associated with a promotion offer, for example, or associated with an offer of an online marketplace or another marketplace medium. The user may submit the purchase initiation code through the network-based device while in an established communication session with the payment module 133. The user may be requested to submit verification of identity, such as a password and username, upon making the purchase request, as discussed herein. Payment in connection with the request may be made using the financial service provider, for example, by debiting a first user account and crediting a second user account (or vendor account), accordingly. A means for transferring the payment is through the payment module 133.

### Application Server(s)

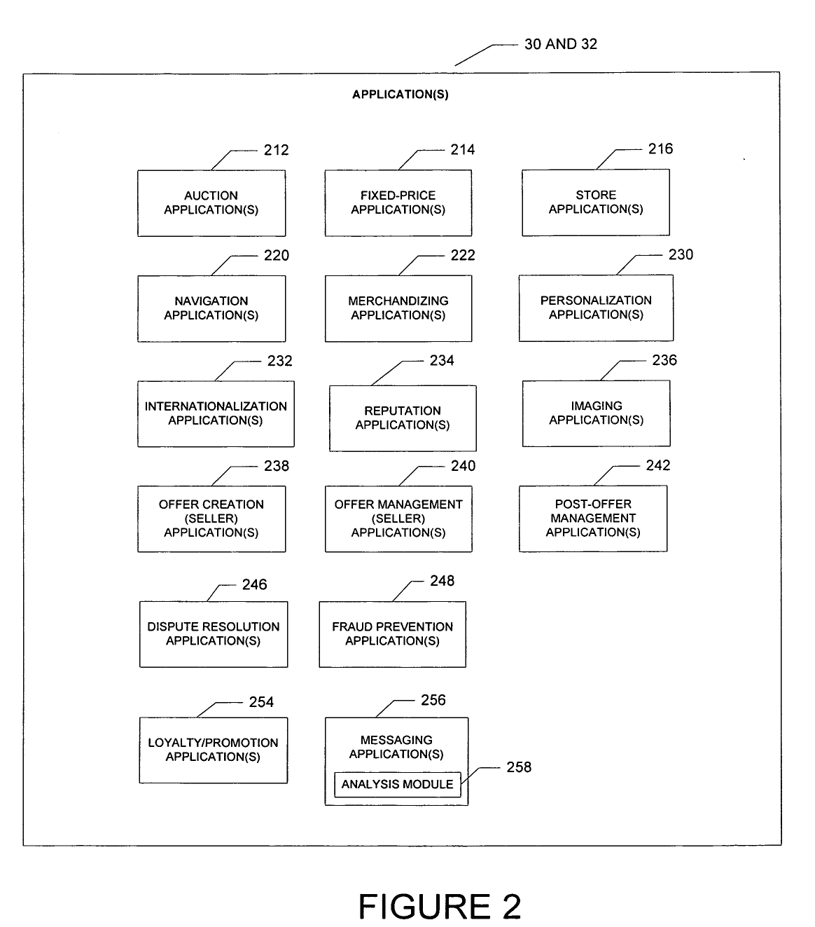

FIG. 2 illustrates a block diagram showing application server(s) that are part of the network-based system 112, in an example embodiment of the present invention. In this embodiment, the marketplace application(s) 130, and the payment application(s) 132 may be hosted by the application server(s) 128 of the network-based system 112. The applications 130 and 132 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The marketplace applications 130 are shown to include at least one or more auction applications 212 which support auction-format listing and price setting mechanisms (e.g., English, Dutch, Vickrey, Chinese, Double, Reverse auctions etc.). The auction applications 212 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer.

One or more fixed-price application(s) 214 support fixed-price listing formats (e.g., the traditional classified advertisement-type listing or a catalogue listing) and buyout-type listings. Specifically, buyout-type listings (e.g., including the Buy-It-Now® (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

The application(s) of the application server 128 may include one or more store application(s) 216 that allow a seller to group listings within a “virtual” store. The virtual store may be branded and otherwise personalized by and for the seller. Such a virtual store may also offer promotions, incentives and features that are specific and personalized to a relevant seller.

Navigation of the online marketplace may be facilitated by one or more navigation applications 220. For example, a search application (as an example of a navigation application) may enable key word searches of listings published via the networked system 112. A browse application may allow users to browse various category, catalogue, or inventory data structures according to which listings may be classified within the networked system 112. Various other navigation applications may be provided to supplement the search and browsing applications.

Merchandizing applications 222 support various merchandising functions that are made available to sellers to enable sellers to increase sales via the networked system 112. The merchandizing applications 222 also operate the various merchandising features that may be invoked by sellers, and may monitor and track the success of merchandising strategies employed by sellers.

Personalization applications 230 allow users of the networked system 112 to personalize various aspects of their interactions with the networked system 112. For example, a user may, utilizing an appropriate personalization application 230, create a personalized reference page at which information regarding transactions to which the user is (or has been) a party may be viewed. Further, the personalization application(s) 230 may enable a third party to personalize products and other aspects of their interactions with the system 112 and other parties, or to provide other information, such as relevant business information about themselves.

The marketplace applications 110 may include one or more internationalization applications 232. In one embodiment, the network-based system 112 may support a number of marketplaces that are customized, for example, for specific geographic regions. A version of the system 112 may be customized for the United Kingdom, whereas another version of the system 112 may be customized for the United States. Each of these versions may operate as an independent marketplace, or may be customized (or internationalized) presentations of a common underlying marketplace. The networked system 112 may accordingly include a number of internationalization applications 232 that customize information (and/or the presentation of information) by the networked system 112 according to predetermined criteria (e.g., geographic, demographic or marketplace criteria). For example, the internationalization applications 232 may be used to support the customization of information for a number of regional websites that are operated by the networked system 112 and that are accessible via respective web servers.

Reputation applications 234 allow users that transact, utilizing the networked system 112, to establish, build and maintain reputations, which may be made available and published to potential trading partners. Consider that where, for example, the networked system 112 supports person-to-person trading, users may otherwise have no history or other reference information whereby the trustworthiness and credibility of potential trading partners may be assessed. The reputation applications 234 allow a user, for example through feedback provided by other transaction partners, to establish a reputation within the networked system 112 over time. Other potential trading partners may then reference such a reputation for the purposes of assessing credibility and trustworthiness.

In order to make listings, available via the networked system 112, as visually informing and attractive as possible, the marketplace applications 130 may include one or more imaging applications 236 utilizing which users may upload images for inclusion within listings. An imaging application 236 also operates to incorporate images within viewed listings. The imaging applications 236 may also support one or more promotional features, such as image galleries that are presented to potential buyers. For example, sellers may generally pay an additional fee to have an image included within a gallery of images for promoted items.

The marketplace applications 110 may include one or more offer creation applications 238. The offer creation applications 238 allow sellers conveniently to author products pertaining to goods or services that they wish to transact via the system 112. Offer management applications 240 allow sellers to manage offers, such as goods, services, or donation opportunities. Specifically, where a particular seller has authored and/or published a large number of products, the management of such products may present a challenge. The offer management applications 240 provide a number of features (e.g., auto-reproduct, inventory level monitors, etc.) to assist the seller in managing such products. One or more post-offer management applications 242 also assist sellers with a number of activities that typically occur post-offer. For example, upon completion of an auction facilitated by one or more auction applications 212, a seller may wish to leave feedback regarding a particular buyer. To this end, a post-offer management application 242 may provide an interface to one or more reputation applications 234, so as to allow the seller conveniently to provide feedback regarding multiple buyers to the reputation applications 234.

The dispute resolution application(s) 246 may provide mechanisms whereby disputes arising between transacting parties may be resolved. For example, the dispute resolution applications 48 may provide guided procedures whereby the parties are guided through a number of steps in an attempt to settle a dispute. In the event that the dispute cannot be settled via the guided procedures, the dispute may be escalated to a mediator or arbitrator.

The fraud prevention application(s) 248 may implement various fraud detection and prevention mechanisms to reduce the occurrence of fraud within the system 112. The fraud prevention application(s) may prevent fraud with respect to the third party and/or the client user in relation to any part of the request, payment, information flows and/or request fulfillment. Fraud may occur with respect to unauthorized use of financial instruments, non-delivery of goods, and abuse of personal information.

The network-based system 112 itself, or one or more parties that transact via the system 112, may operate loyalty programs and other types of promotions that are supported by one or more loyalty/promotions applications 254. For example, a buyer/client user may earn loyalty or promotions points for each transaction established and/or concluded with a particular seller/third party, and may be offered a reward for which accumulated loyalty points can be redeemed.

The application server(s) 128 may include messaging applications 256. The messaging applications 256 are responsible for the generation and delivery of messages to client users and third parties of the network-based system 112. Information in these messages may be pertinent to services offered by, and activities performed via, the marketplace application(s) 130 and/or the payment application(s) 132.

Such messages, for example, advise client users regarding the status of products (e.g., providing “out of stock” or “outbid” notices to client users) or payment status (e.g., providing receipt for payment, Notification of a Payment Received, delivery status, invoice notices). Third parties may be notified of a product order, payment confirmation and/or shipment information. Respective messaging applications 256 may utilize any one having a number of message delivery networks and platforms to deliver messages to users. For example, messaging applications 256 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Sample messages may include a basic seller focused message, such as a congratulations on registering or selling, a reminder to list, education to get to first listing or re-listing including Selling Tools, features information, Selling Education (tips), Trading Assistant, in-person training, Selling Tutorials, buying tutorials (e.g., how to buy a vehicle online), inspection report services (e.g., AutoCheck® for buyers of vehicles), hints for sellers—popular categories, toolbar, and listing promotions. Other education may include proxy bidding, fixed price buying, Toolbar, address barriers to success, and search education. Further, other categories of items have services to complete the transaction, including shipping (e.g., free shipping quotes, for example, at www.Freightquote.com for heavy/large items), and financing (e.g., low monthly payments) services.

The messaging application(s) may include an analysis module 258 to decide which users or webpages may receive particular messages and/or promotions. The analysis module may also be considered a rules engine to allow segmentation rules based on targeting attributes (inputs to rules). Based on these inputs, the rules engine may determine whether the current user falls into any of the predefined segments. If a targeted message exists for the placement, the rules engine determines the current user segment based on the targeting attributes (of table 316) available.

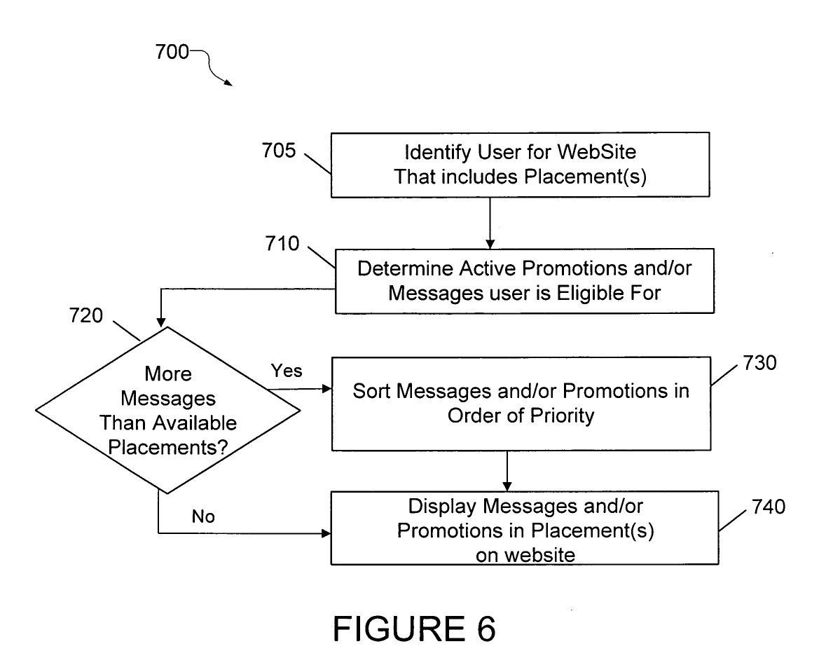

The analysis module 258 receives rule conditions from a rules table 320, and targeting attributes from a table 316, including user attributes from a table 302 as input for determination of promotions published to the user in real-time while the user is launching or viewing a website of the system 112. The analysis module 258 outputs the rule conditions that the current user qualifies for, as well as the associated promotion information. The analysis module 258 is further discussed with regard to the flowchart of FIG. 6.

### Data Structures

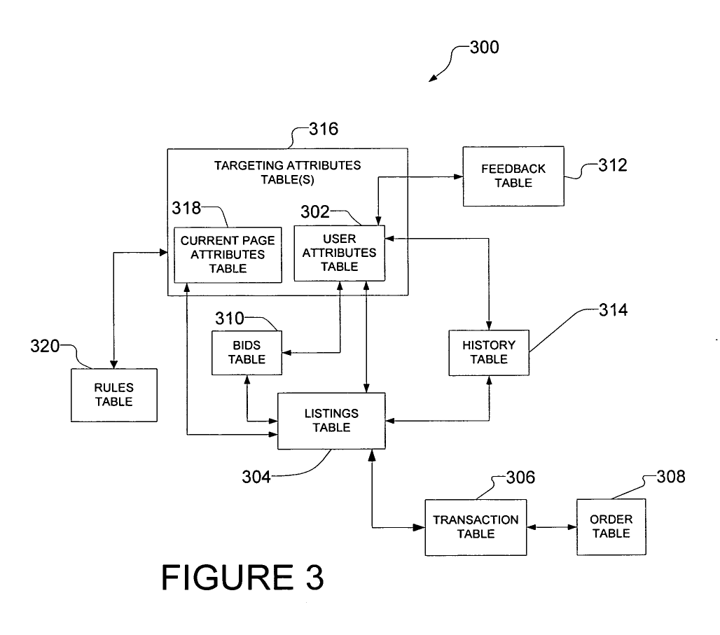

FIG. 3 illustrates a high-level entity-relationship diagram, having various tables 300 that may be maintained within the database(s) 136 according to an example embodiment. The tables 300 may be utilized by and support the application(s) of the application server(s). The database(s) 136 may, in one embodiment, be implemented as a relational database, and includes a number of tables having entries, or records, that are linked by indices and keys. In an alternative embodiment, the database(s) 136 may be implemented as a collection of objects in an object-oriented database.

A user attributes table 302 contains a record for each registered user of the networked system 112. A user may operate as a seller, a buyer, or both, within the networked system 112. In one example embodiment, a buyer may be a user that has accumulated value (e.g., commercial or proprietary currency), and is accordingly able to exchange the accumulated value for items that are offered for sale by the networked system 112.

The user attribute(s) may be selected from a group including: age, gender, number of feedbacks obtained, positive feedback percentage, verifiable street address on file, time on file (length of time), associated country, date of first listing, date of last listing, total number of listings (and frequency of listing), total number of listings that sold, date last used PayPal®, date a particular feature was last used, total number of times a particular feature was used, email option (to indicate whether the user has opted in to receive marketing emails associated with the system), user site ID, last usage date of site specific features, such as Toolbar®, number of posts of wanted items, such as Want-it-Now® postings, and corresponding dates, response dates for wanted items, subscriber to personalized sales reports, web site registration date, number of transactions completed where a particular financial service provider (such as PayPal® or Escrow) was accepted, number of user received a non-paying bidder notice from a seller and dates.

The user attribute(s) may be selected from a group including: number and dates of cross border transaction and respective prices for both sold and bought, cross border, selling format usage (e.g., auction, fixed price, dutch auction, multiple items, store inventory, best offer, real estate Advertisement, second chance offer, etc.), listing categories as a seller, listing categories as a buyer, successful listings percentages and numbers, active seller in last x days, store anniversary, just opened a store in the online marketplace, just reopened store (basic or features), selling tool usage, usage of selling features (such as subtitle), power seller status, date of first bid in online auction of online marketplace, last payment method used as a buyer, primary and secondary categories in which the buyer placed the most bids, number of purchases and successful winning bids and fixed price purchases in primary and secondary categories, total number of categories in which the buyer placed winning bids or had fixed-price purchases, date of first purchase, date of last bid, number and type of purchased listings in a day (type of purchase can be from auction, fixed price, dutch auction, multi-item, store inventory, real estate, second chance offer, or combinations thereof), buyer saved category on personalized page, buyer saved searches on personalized page, last purchase date with specific financial service provider, gift certificate amount used, total number of items on user's watch list, user ID, postal code, email domain, status code (example), seller feedback, buyer feedback, promotions used and status, specific financial service provider preferred and account status.

User lists may target users for promotions and/or messages. The lists may be generated from the data in the user attribute(s) table 302. The user list segments may originate from any external source as long as the users may be matched with and user ID (ex: excel, an address book, an external database, other off line sources, etc). The user list segments can be uploaded in the database on demand. The user list segments allow identification and personalization of the webpage system content for any user part of the user list segments in substantial real time as the user views various system webpages. Examples of user lists include: list of users living in London, New Castle and Bristol; list of users that have been contacted by the system sales team and those that will receive promotions; list of users that have attended in person a training course sponsored by the network-based system; list of users that have reached their 5 year anniversary on the system; high value customers that will receive Holiday gift certificates; top sellers on the system that receive a fee discount.

The tables 300 also include a listings or items table 304 in which are maintained item records for goods and services that are available to be, or have been, transacted via the networked system 112. Each item record within the items table 304 may furthermore be linked to one or more user records within a user table 302, so as to associate a seller and one or more actual or potential buyers with each item record.

A transaction table 306 contains a record for each transaction (e.g., a purchase or sale transaction) pertaining to items for which records exist within the items table 304. In addition to transactions taking place between users on the system, the transaction table 306 may include a record for the specific transaction (e.g., a purchase transaction) under consideration. The transaction table 306 may include information such as the user, the category or other listing features, status, price paid, date, and other transaction-related information.

An order table 308 is populated with order records, each order record being associated with an order. Each order, in turn, may be with respect to one or more transactions for which records exist within the transaction table 306.

Bid records within a bids table 310 each relate to a bid received at the networked system 112 in connection with an auction-format listing supported by an auction application 328. A feedback table 312 is utilized by one or more reputation applications 234, in one example embodiment, to construct and maintain reputation information concerning users. A history table 314 maintains a history of transactions to which a user has been a party.

One or more targeting attributes tables 316 record attribute information pertaining to which webpages and users are targeted for certain messages or promotions. The targeting attributes define which parameters may be used to target the messages or promotions. The targeting attributes tables 316 include a current page attribute(s) table 318 as well as the user attributes table 302.

Messages/Promotions may be offered based on criteria or conditions, such as characteristics of the user or behavior on the marketplace, which are objective and achievable by each user equally.

Besides users that have characteristics such as those in the user attribute(s) table 302, and current page attributes of the current page attributes table 318, other targeting attribute(s) 316 may include: new registered users on system, users that registered, 7, 15, 30 or x days ago on the system, users that buy items primarily from a particular category, for example, in the DVD, collectible or motors categories, users that sell items primarily on the system, users that have an online store on the system, users that prefer specific payment methods (e.g., credit card, check, PayPal®), users that subscribe to specific tools, e.g., TurboLister®, Toolbar, Selling manager, users viewing an item having a price in a certain price range, e.g., between $500 and $3000; users viewing a certain category item, e.g., a passenger vehicle that has a v6 engine or an item in a DVD, Camera or Jewelry category.

The current page attributes table 318 may include the following attributes: country identification; and type of current page; e.g., home page, or personalized page, or view item page. The current page attributes may be a contextual page attribute, e.g., information in the page that conveys what the user is doing. The contextual information may be from a page in addition to, or instead of, the user information.

Other attributes of the current page attributes table 318 may include attributes directed towards a listing on for example, a view item page. The listing attributes may include site, country ID, location ID; format; category; PayPal® accepted; shipping instructions; which features are selected; catalog based; product ID; item return policy; starting price; price range; fixed-price amount; reserve price; bids; quantity of items for listing; currency selected for listing; number of photos; item sequence number, item duration; item re-listed; item listed in 2nd category; application ID; item return policy; listing tool used and user login.

The tables 300 may include one or more rules tables 320 listing the rule conditions used by the analysis module 258. A rule defines an item context. The rules table and associated analysis module offers the flexibility to add, remove, and/or modify promotions without incurring additional development by simply modifying the rules table. The rule may be of the form: IF (IF Statement—a.k.a. Input Conditions), THEN (Return context name). Segments include business rules in the rules table 320 that are based on user history and computed by the rules engine in substantial real-time based on data associated with the current user.

Different segmentation types may be combined together. The rule may have a first component associated with the user list and having a second component associated with the current page attribute (contextual). Examples of rules include: personalized credit offers for items in the Passenger Vehicle category (contextual) for users that are part of the top 100 best customer list (user list segment); promotions for users viewing a DVD page (contextual) and that are buyers primarily in the DVD category (historic segment) or that have been contacted by the sales team about DVD offers on the network-based commerce system (user list).

Segmentation (rules) may be defined by the network-based commerce system on the fly (or in near real-time) based on user-behavior on site. Rules tables may be adjusted “on the fly” using reports received about current user browsing. Such quick adjustment may accommodate community, service partner, and business needs.

Sample rules that use item attributes, category, and other criteria include: Collector Car services offered when attributes indicate: Passenger Vehicles category, Year is 1981 or earlier. Newbie Car Buyer message offered when attributes indicate: Passenger Vehicle category; User first registration <90 days or User is not registered. Car Financing offered when attributes indicate: Passenger Vehicle category; Make=<values>; User is registered. Used Motorcycle Financing offered when attributes indicate: Category=Motorcycles; Condition=Used; and Warranty=No.

While the criteria of message/promotion conditions themselves may increase in complexity due to the availability of the algorithm, the volume of message/promotions may also increase significantly. Due to limited real estate on a website, certain messages or promotions take priority as outlined in the flow chart of FIG. 6.

### User Interface

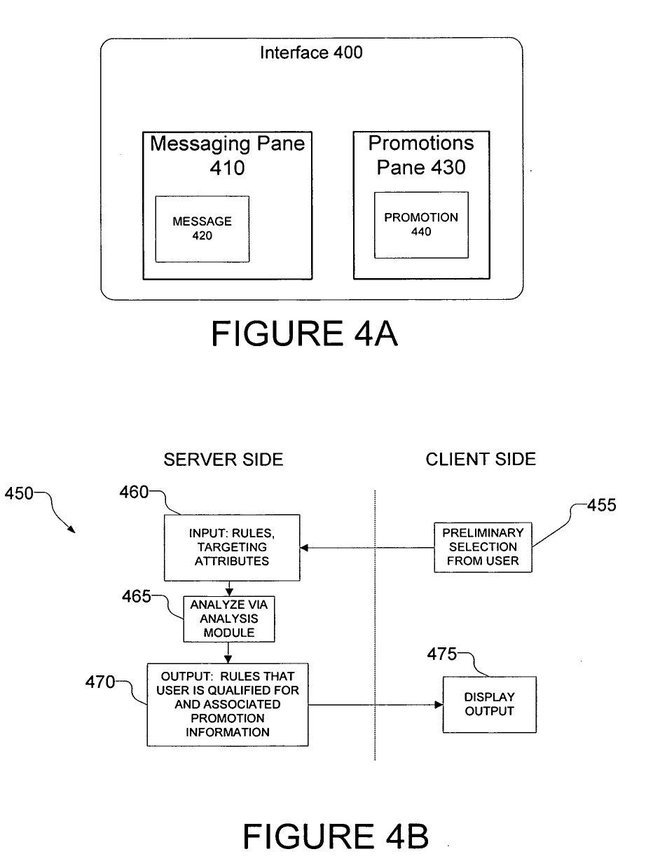

FIG. 4A illustrates a user interface 400, for example a website of the network-based commerce system. A messaging pane or placement 410 may include a message 420, as described herein, and a promotions pane 430 may include a promotion 440 as described herein. Within these panes may be displayed information related to PayPal®; a service promotion; recommended services; recommended items to buy on the marketplace or nothing.

The interface 400 may include a web page associated with the network based system, such as a home page of the network-based system, a personalized homepage of the system for the user, sign out page, buy (or search or browse) page, search results page, sell page (to list items for sale), or a view item page, for instance. The message and/or promotion may be placed in a placement on a view item page, such as an active item page; a closed item page; an outbid page; a highest bidder page; and/or any other permutation of a view item page.

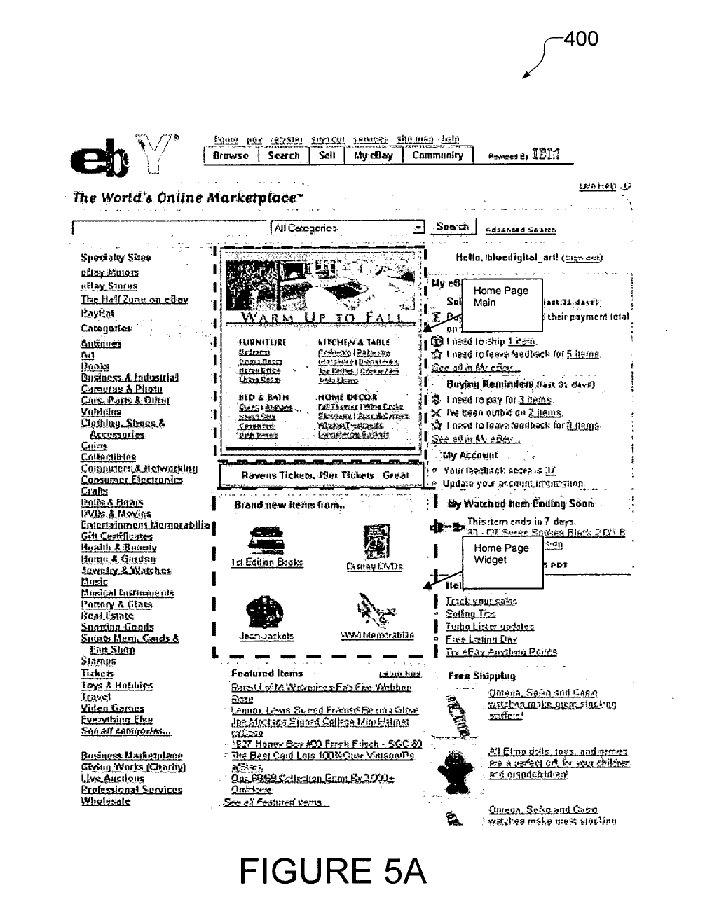

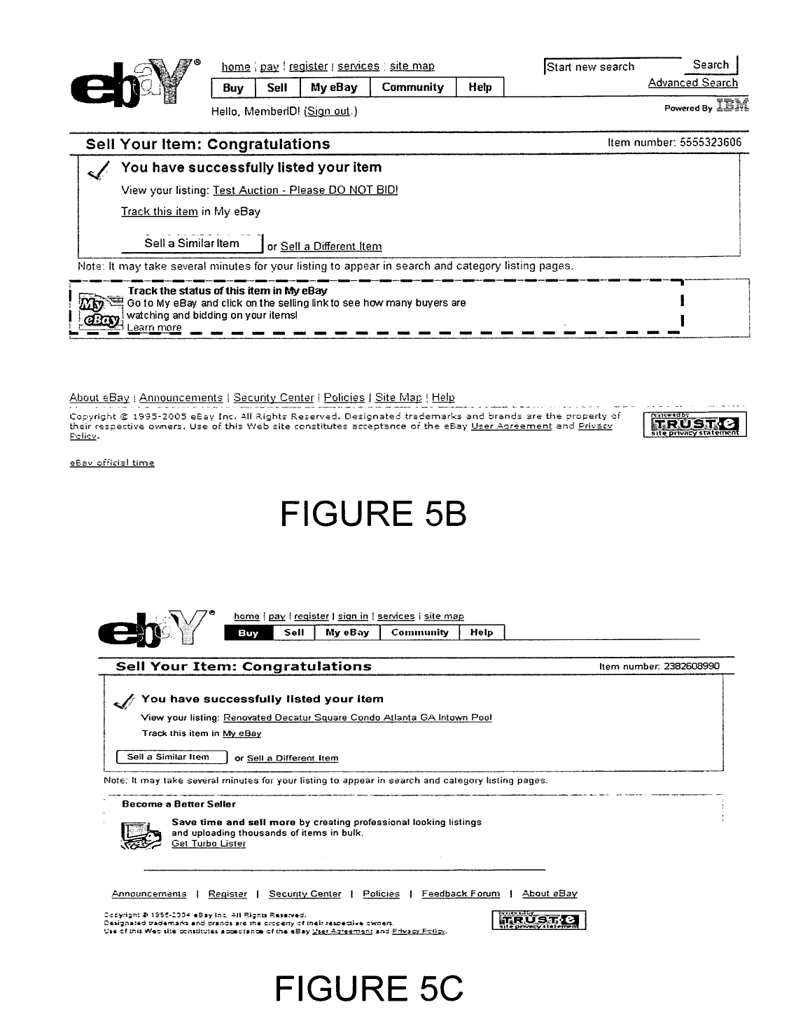

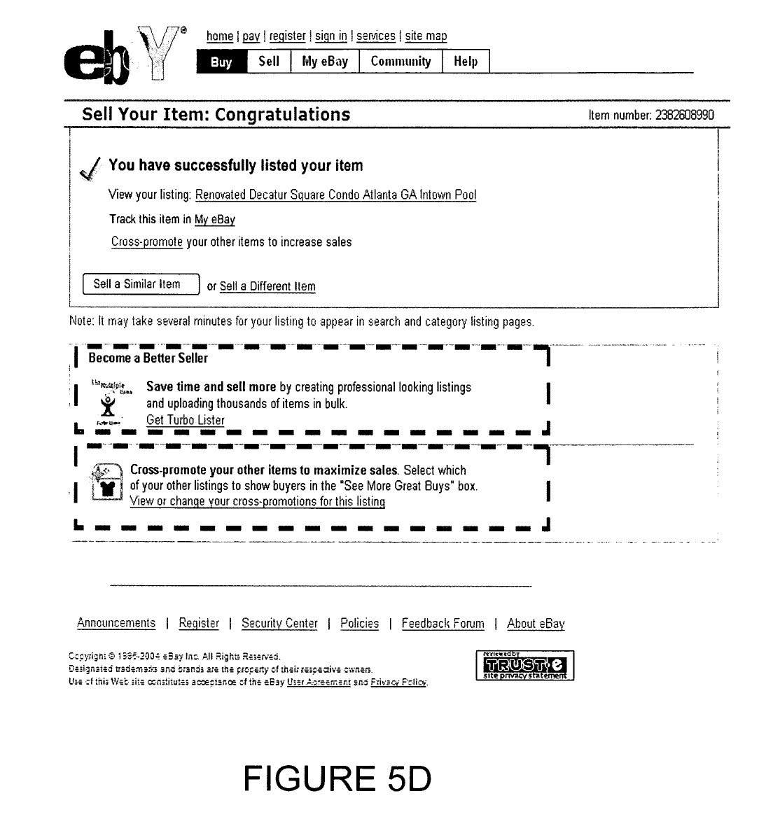

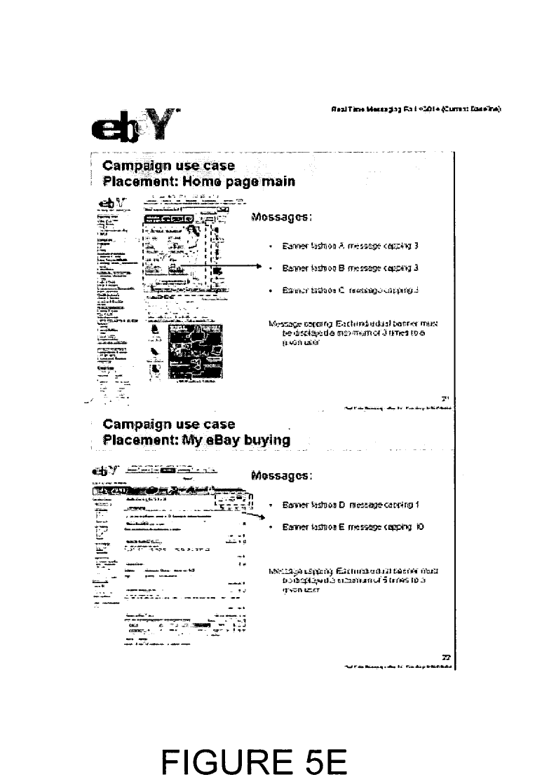

The placements may include a banner, a static HTML, or content served by a third party system as shown in more detail in FIGS. 5A to 5E.

### Interaction Chart

FIG. 4B illustrates an interaction chart 450 in an example embodiment. In the interaction chart 450, a preliminary selection is made at 455 by a user on the client side. The preliminary selection may be a simple login by the client, and may be a selection of category into which to place the listing, or launching a website associated with the network-based commerce system, or any other possible trigger as a preliminary selection of a purchase on the system 112. At 60, on the server side, rule conditions from the rules table 320, targeting attributes from the corresponding table 316, and user attributes from the corresponding table 302 are input into the analysis module 258 at 465 for determination of promotions or messages published to the user in “real-time” while the user is listing their offer on the system 112. At 470, the analysis module 258 outputs the rule conditions that the current user qualifies for, as well as the associated message or promotion information. This information is displayed in “real-time” to the user at the client side on the current webpage. The user makes a selection that may or may not include the promotion or message.

### User Interfaces

FIGS. 5A to 5E illustrate various interfaces according to an example embodiments. The various interfaces illustrate various locations of placements on the various web pages associated with the network-based device.

In particular, FIG. 5E illustrates an interface showing a promotion targeted to users that have less experience in the particular featured category (ex: fashion), for example have less than 3 cumulative purchases in that category.

As shown in FIGS. 5A to 5E, the messages and/or promotions may be HTML. Static HTML—the HTML may contain actual text as well as picture references and links. Static HTML: free form text, links and pictures. Banner: picture+link or picture+image map. The messages/promotions may be altered depending upon the language or country associated with the home page.

### Flowcharts

FIG. 6 illustrates a flow chart of a method 700, according to an example embodiment of the present invention.

The method 700 includes at 705, identify user for each site that includes a placement or placements. If the user is not identified, the system may attempt to display a non-targeted message or promotion for the placement. Identification mechanisms may include user login, or another type of user authentication, or existing cookies on the device,

At 710, active promotions or messages that the user is eligible for, or qualifies for may be determined based on targeting attributes and rules, user lists, and current webpage being launched or viewed. Analysis module 258 determines if user is qualified to receive a promotion, based on seller and/or listing attributes. In the case of more messages and promotions than placements, the analysis module is used to resolve these cases in real-time while the website is loading.

At 720, query whether there are more promotions or messages to display than available placements on the site. If yes, then proceed to 730. If no, then proceed to 740.

At 730, sort promotions and/or messages in order of priority. The campaign with the highest priority is selected and the segment repository is called to define if the current user and context matches the segment for the campaign.

If the campaign and/or the message is displayed for the first time to the user and if the campaign/message capping is defined, a read left/read count may be initialized. Each message that has not reached their capping may be retrieved by the analysis module 258. Among those messages the message with the highest “read left” is selected to be displayed. A message without capping may be considered as having a read left of 0. Note: readleft/read count is defined when the message has a capping. If several messages have the same “read left”, a random message is sent to the placement to be displayed. If the message/campaign capping is defined, the message/campaign “read left” for the current user is decremented (i.e. read count is incremented). If the Total campaign capping is defined, the impression campaign read count is incremented. Whenever a click or conversion occurs, if the Total campaign impression capping or the Total campaign conversion capping is defined, the click count or conversion count is incremented. Each active campaigns that has not yet reached their Total campaign click capping, campaign capping and message capping for the current user are selected and sorted by priority.

Another example of determining priority placements includes the following: 1) If there is PayPal® Promotion, PayPal® promotion is shown. 2) Besides PayPal® promotion, if there is a message/promotion campaign, show promotion; otherwise, if there is service promotion, show service promotion, otherwise show recommended services, which may be considered as a default placement.

At 740, display promotion(s) and/or message(s), if any, in placements available on the website.

### Platform Architecture

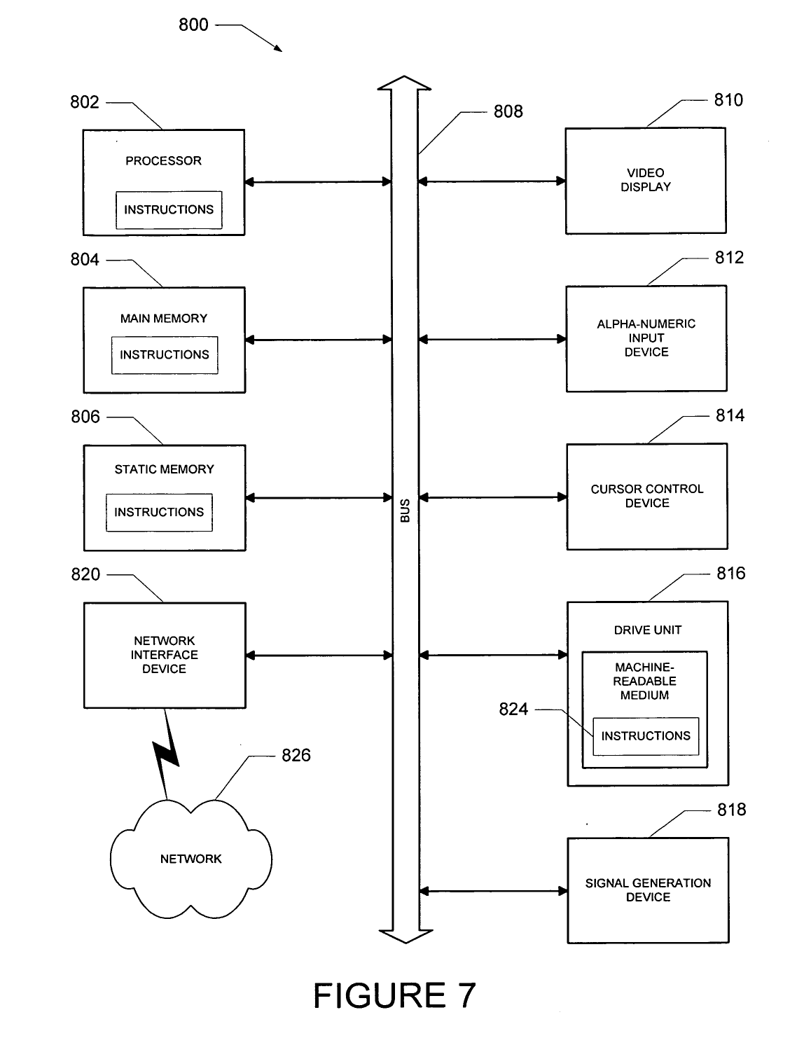

FIG. 7 shows a diagrammatic representation of a machine in the example form of a computer system 800 within which a set of instructions, for causing the machine to perform any one or more of the methodologies discussed herein, may be executed. In alternative embodiments, the machine operates as a standalone device or may be connected (e.g., network) to other machines. In a network deployment, the machine may operate in the capacity of a server or a client user machine in server-client user network environment, or as a peer machine in a peer-to-peer (or distributed) network environment. The machine may be a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a television, television cable a pager, a personal trusted device, a web appliance, a network router, switch or bridge, or any machine capable of executing a set of instructions (sequential or otherwise) that specify actions to be taken by that machine.

Further, while a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies or functions described herein. The instructions 824 may also reside, completely or at least partially, within the main memory 804, the static memory 806, and/or within the processor 802 during execution thereof by the computer system 800. The main memory 804 and the processor 802 also may constitute machine-readable media.

The instructions 824 may further be transmitted or received over a network 826 via the network interface device 820.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. FIGS. 1 to 7 are merely representational and may not be drawn to scale. Certain proportions thereof may be exaggerated, while others may be minimized.

Thus, a method and system to publish a promotion at a point-of-sale have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The description includes terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the examples of dimensions and ranges are considered typical, the various embodiments are not limited to such dimensions or ranges.

The Abstract may be provided to comply with 37 C.F.R. § 1.74(b) to allow the reader to quickly ascertain the nature and gist of the technical disclosure. The Abstract is submitted with the understanding that it will not be used to interpret or limit the scope or meaning of the claims. In the Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

What is claimed is:

1. An electronic system to publish a message at a current user web page, the system comprising:
a database including a user list, a current page attribute, and a rule having a first component associated with the user list and having a second component associated with the current page attribute; and
a rules engine to apply the rule using the user list and the current page attribute to publish a message to a user at a current user web page.

2. The system of claim 1 wherein the message includes a discount associated with a purchase or wherein the message includes a recommendation or a tip related to the electronic system.

3. The system of claim 1 wherein the current page attribute is associated with information of the current user web page, and includes a price range associated with a listing on the current user web page.

4. The system of claim 1 wherein the rule is directed towards at least one selected from a group including: new registered users on system, users that registered less than a particular number of days ago, users that buy items primarily from a particular category, users that sell items primarily on the system, users that have an online store on the system, users that prefer specific payment methods, users that subscribe to specific on-line tools, users viewing an item having a price in a certain price range, and users viewing a certain category item.

5. The system of claim 1 wherein the current page attribute is selected from a group of attributes including country identification associated with the current page, and a current page type.

6. A method to publish a message at a current user web page of a network-based commerce system, the method comprising:
applying an analysis module to a rule having a user list component and a current page attribute component to publish a message to a user at the current user web page.

7. The method of claim 6 wherein the message includes a discount associated with a purchase or wherein the message includes a recommendation or a tip related to the system.

8. The method of claim 6 wherein the current page attribute component is associated with information of the current user web page, and includes a price range associated with a listing on the current user web page.

9. The method of claim 6 wherein the rule is directed towards at least one selected from a group including: new registered users on system, users that registered less than a particular number of days ago, users that buy items primarily from a particular category, users that sell items primarily on the system, users that have an online store on the system, users that prefer specific payment methods, users that subscribe to specific on-line tools, users viewing an item having a price in a certain price range, and users viewing a certain category item.

10. The method of claim 6 wherein the current page attribute component is selected from a group of attributes including country identification associated with the current page, and a current page type.

11. A machine-readable medium storing a sequence of instructions that, when executed by a computer, cause the computer to perform the method of claim 6.

12. A network-based commerce system to publish a message at a current user web page, the system comprising:
means for storing a user list, a current page attribute, and a rule having a first component associated with the user list and having a second component associated with the current page attribute; and
means for applying an analysis module to the rule using the user list and the current page attribute to publish a message to a user at a current user web page.
